(19) United States
(12) Patent Application Publication
(10) Pub. No.: US 2014/0337425 A1
(43) Pub. Date: Nov. 13, 2014

(54) MODIFYING A SOCIAL GRAPH BASED ON LANGUAGE PREFERENCE

(71) Applicant: GOOGLE INC., Mountain View, CA (US)

(72) Inventors: Kirill BURYAK, Sunnyvale, CA (US); Andrew Swerdlow, San Francisco, CA (US); Luke Hiro SWARTZ, San Francisco, CA (US); Cibu Johny, Santa Clara, CA (US)

(21) Appl. No.: 13/892,850

(22) Filed: May 13, 2013

(51) Int. Cl. H04L 29/08

(52) U.S. Cl. CPC H04L 67/22
USPC 709/204

(57) ABSTRACT

Social networking applications may provide an enhanced user experience by considering information regarding the language preference of a user as well as other signals. According to the implementations disclosed herein, one or more signals may be utilized to determine the language in which content may be displayed to a user of a social networking application or website. A first language preference for a user may be determined based on at least one signal. A second language preference may be determined for a social graph component of the social networking application based on at least one signal. The first language preference may be compared to the second language preference and a weighted value may be assigned to the social graph component. The social graph component of the social networking application may be presented based upon the weighted value assigned to the social graph component.

### BACKGROUND

A social graph may describe a user's relationship to the rest of the world, for example by modeling or showing the type of relationship the user has with a variety of other entities. For example, it may include a user's friends or groups thereof, favorite restaurants or hang-outs, a user's hobbies, and/or a user's interests. Social networking applications may provide users with the ability to create or modify their social graph. For example, users may elect to associate with a person of interest, an interest group, a friend, an image, or an audio or video content. A social graph or a component thereof may be provided via an application or a web browser. In some cases, an application may provide suggestions to a user as to how relationships in the user's social graph may be added or modified, such as where a social networking website offers a friend suggestion based on the probability that the friend is known by the user.

### BRIEF SUMMARY

According to an implementation of the disclosed subject matter, a first language preference for a user may be determined based on a first one or more signals. The first language preference may be stored to a computer readable medium and accessed from the computer readable medium by a social networking application. A second language preference may be determined for a social graph component of the social networking application based on a second one or more signals and compared to the second language preference. A weighted value may be assigned to the social graph component based upon the comparison of the first language preference to the second language preference. The more closely aligned the second language preference of the social graph component is to the first language preference of the user, the greater the weighted value it receives. The weighted value may indicate a likelihood that the user prefers to receive the social graph component associated with the first language. The social graph component of the social networking application may be presented based upon the weighted value assigned to the social graph component.

In an implementation, a system is provided that includes a database storing a number of signals and a processor connected to the database that is configured to determine a first language preference for a user based on a first one or more signals. A second language preference for a social graph component may be determined based on a second one or more signals. The processor may compare the first language preference to the second language preference, and assign a weighted value to the social graph component based upon the comparison. The weighted value may indicate a likelihood that the user prefers to receive the social graph component associated with a first language preference. The processor may be configured to present the social graph component of the social networking application based upon the weighted value assigned to the social graph component.

In an implementation, information for presenting a language preference selection control may be sent to a user. A selection of a first language preference by a user may be received and stored to a computer readable medium, from where it is accessible by a social networking application. A determination of whether the content of the social networking application is associated with a second language preference may be made. The first language preference may be compared to the second language preference to determine a language based presentation for the content, and social networking application content may be presented accordingly. Presenting may include, for example, filtering a social graph of the user based upon the language preference of the user, translating the content according to the language preference of the user, or the like.

In an implementation of the disclosed subject matter, at least one signal, which may include a language preference, may be received. A signal also may include, for example, an online activity of the user, a music selection of the user, a media selection of the user, a frequency of posts of the user in a social network application, an email, a comment of the user, a length of a text item accessed by the user, an amount of time spent reading a text item, a text item provided by the user, a speech of the user, a language proficiency of the user, or any combination thereof. A first language for a user may be determined based on the signal. A second language may be determined for content available to a social networking application based on the same or another signal. The first language may be compared to the second language to determine a final language, and content of the social networking application may be presented in accordance with the determined final language.

In an implementation of the disclosed subject matter, a system is provided that includes a database storing at least one signal, and a processor that is connected to the database that is configured to receive the signal, such as by receiving a language preference from a user. The processor may be configured to determine a first language for a user and second language for content available to a social networking site based on at least one of the signals. The first language may be compared to the second language to determine a final language, in which content of the social networking application may be presented. The step of presenting the content may include promoting a language specified in the language preference of the user, such as by modifying the amount of content of the language to be presented to the user. The content of the social networking application may be presented in a variety of ways, such as filtering a social graph of the user based upon the language preference of the user, publishing to a social networking application, grouping individuals associated with the user, translating the content according to the language preference of the user, or the like. In addition, the formatted content of the social networking application may be stored to a computer readable medium.

Implementations as disclosed herein may leverage a user's language preferences to filter the user's social graph based on the language the user speaks. Connections or relationships within a user's social graph may be generated based on the user's language preferences and allow the user to filter comments or posts based on the user's language preferences, and may allow for suggestions to a user's social graph based on the user's language preferences, the user's language proficiency, and/or the user's social graph. Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example arrangement and information flow for social graph modification based upon language or language preference according to an implementation of the disclosed subject matter.

FIG. 4 shows an example of a computational system configured to respond to at least one signal and present a social graph component according to an implementation of the disclosed subject matter.

FIG. 5 shows an example of filtering a social graph based on a user's language preference according to an implementation of the disclosed subject matter.

FIG. 6 shows an example arrangement and information flow for social content modification based upon at least one signal according to an implementation of the disclosed subject matter.

FIG. 7 shows an example of a computational system configured to respond to the language preference input and present filtered content of the social networking application according to an implementation of the disclosed subject matter.

### DETAILED DESCRIPTION

Many users are multilingual and may benefit from having language considered in their social graph. For example, a user who is fluent in French, Chinese, and Hindi may desire to receive suggestions about potential persons of interest, content, a friend suggestion, or an interest group suggestion. The user may also desire to create friend groups based upon the languages in which she is fluent, such as a Hindi-fluent friends group. Utilizing language-based signals to modify the user's social graph may provide for a more tailored user experience on social networking applications.

According to an implementation of the disclosed subject matter, the social graph of a user of a social networking application may be modified based upon the user's language preference. The user's language preference may be based on one or more signals received in the context of a social networking application. For example, a user may receive a suggestion for a person of interest, a friend, an interest group, or the like. A social graph component may be filtered. For example, a subset of a pool of friends who have a particular fluency in a language spoken by the user may be presented to the user as a suggested friend group. A social graph component may refer to the one or more relationships an individual has with the rest of the world. In the context of a social networking application or website, this may include, for example, a friend group, a person of interest, an interest group, or a friend. Information or data may be collected from individual users, in the form of signals, which may be used to define a user's social graph and enhance the user's social networking experience by offering suggestions related thereto. A social graph component may represent a subset of the social graph; that is, the sum total of social graph components for a particular user may represent the social graph of that user.

A social graph of a user of a social networking application may be modified based upon the user's language preference in an implementation. The language preference may, for example, determine who may see a posting based upon the language preference of the viewer. It may also allow the user to specify friend groups or persons of interests based upon the user's language preference. More generally, the disclosed subject matter may include modifying the social graph of the user according to one or more signals by, for example, determining the language associated with content and comparing that language to the determined language of the user.

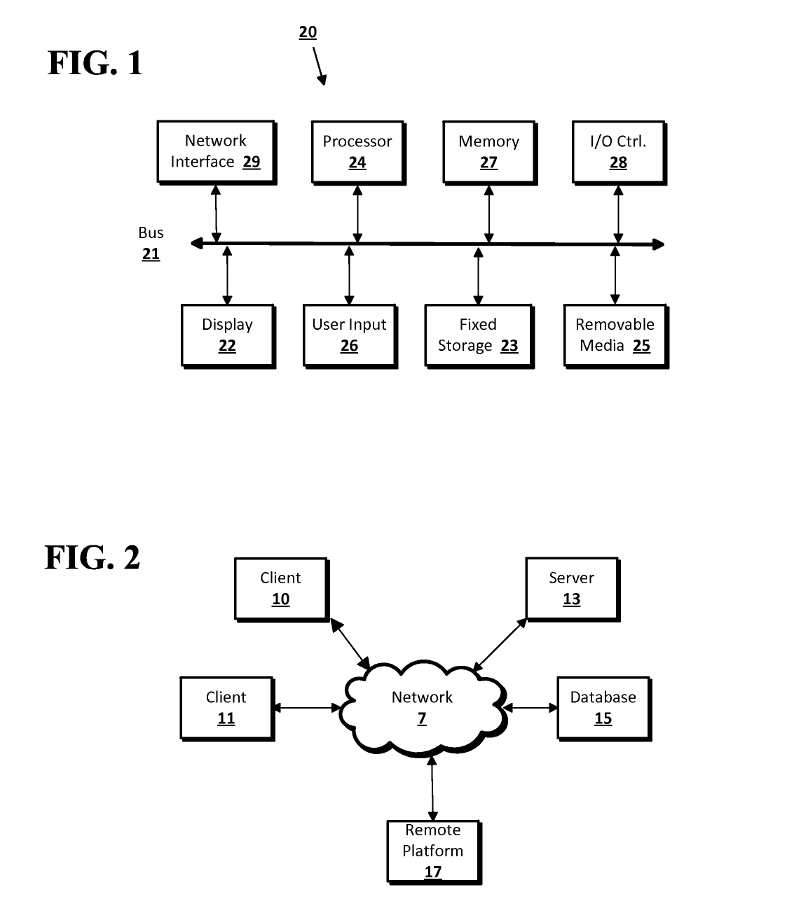

Implementations of the presently disclosed subject matter may be implemented in and used with a variety of component and network architectures. FIG. 1 is an example computer 20 suitable for performing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be performed using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

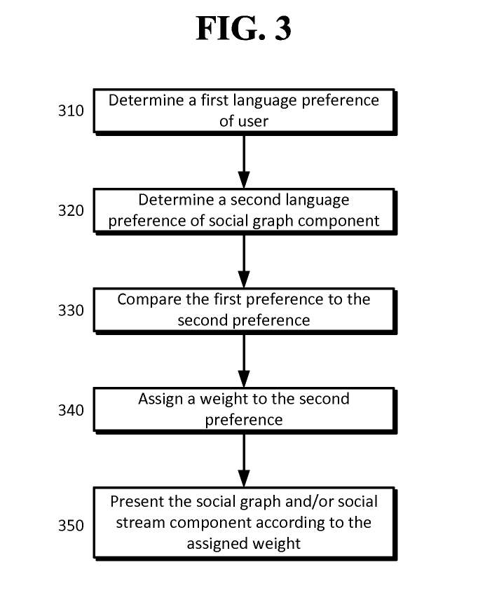

FIG. 3 shows an example implementation of the disclosed subject matter. At 310, a first language preference for a user may be determined based on a first at least one signal. Typically, a signal may refer to data within the context of a social networking application. A signal may include, for example: an online activity of the user, a music selection of the user, a media selection of the user, a frequency of posts by the user to a social network, an email, a comment by the user, a length of a text item accessed by the user, an amount of time spent reading a text item, a text item provided by the user, a speech of the user, a language proficiency, a user-input language preference as described below, a language indicator as described below, or a combination thereof. A language proficiency may be determined through a machine learning approach that is applied to, for example, the online activity of the user. Language proficiency may also be specified by the user. For example, a user may indicate a language proficiency for an application using a sliding scale interface. The user may indicate a language proficiency for Hindi as 50% and for Chinese as 75%. A user may indicate a language proficiency by more generalized categories such as the ability to read, write, or speak a given language. A language proficiency may be inferred based upon the user's demonstrated ability to read, write or speak a given language.

A user-input language preference may be obtained, for example, by the user specifying one or more languages in which the user would prefer to receive content. A language preference may be received, for example, as part of a language selection control. The language preference selection control may allow a user to establish a list of languages in which the user would like to have content presented. It may allow a user to specify a hierarchy for language presentation. For example, if the user desires content in French, Chinese, and Hindi, these languages may be indicated in the language preference selection control. The order of the languages also may be recorded or utilized for language resolution of content or as a signal for a machine learning program. Continuing the example, if content is not available for the French language, but is available for Chinese or Hindi languages, a language resolution program may default to the Chinese language for the content because it is the next most-preferred language in which the user desires content to be presented.

A machine learning algorithm or program may be utilized to determine a language preference from the one or more signals. For example, a user may consistently read a German online newspaper, and/or create web-postings that are in German. But the user may not have identified the German language as one in which the user has any fluency. Based on the frequency of using the German language in, for example, the user's web-postings and articles the user reads, a score may be generated that represents the user's language proficiency or fluency for the German language. If the user receives a comment to one of the user's web postings and the comment is in German, given the user's determined proficiency for the German language, the comment may not be translated. If the user's proficiency is determined to be below a threshold and/or low, then the user may be offered a translation of part or all of the comment, for example.

A machine learning algorithm may be trained on a test group of users, each of whom may have a known language proficiency. A language proficiency may be known, for example, where the user specifies a level of proficiency, or where a user's activity is observed and a score is assigned by a qualified professional. One or more signals may be provided to the algorithm and these signals may be used to predict the language proficiency on the test group of users. Subsequent iterations of the algorithm may weigh, add, and/or remove one or more of the signals, and again predict the language proficiency of the test group of users. Once the algorithm has closely or satisfactorily approximated the language proficiency of the test group of users, the machine learning algorithm may be deemed trained, and it may be applied to an experimental sample or other group of users, or signals obtained therefrom.

In some instances, a user may not specify a language preference and the language preference may be inferred or determined from a variety of language indicators other than the user-specified language preference. Typically, language indicators are data received outside of the context of a social networking application. Language indicators may include, for example: (1) a URL parameter, such as a parameter that indicates a previously-selected language or similar setting, (2) a user application-specific override, (3) a general user language preferences, (4) a cookie or setting stored in cookie, (5) a browser accept-language, (6) a language override for another application, which may be arranged in descending usage order, (7) a user agent, (8) an enterprise administrator's language policy setting, and (9) an IP address. For example, a URL parameter may include a computer-readable code, such as “hl=” followed by a language tag, included in a URL to the desired language a user would like a webpage to display. As another example, a cookie can include computer-readable code that can transmit state information from a webpage to a user's browser and from a user's browser to the webpage. Similarly, an “accept-language” computer readable code typically specifies the languages a browser may use.

At 320, a second language preference may be determined for a social graph component of the social networking application based on a second signal. A language preference may be determined based on at least one signal as described above, for example, for the first language preference. As stated earlier, a social graph may describe a user's relationship to the rest of the world, for example by modeling or showing the type of relationship the user has with a variety of other entities. Content may refer to images, audio, video, graphics, text, a user group, an interest group, a person of interest, a friend group. In some contexts content may refer to anything sent to an end user. A social graph component may overlap with forms of content such as a friend group, a person of interest, an interest group, or a friend. In a social networking context, friend associations, interest groups, persons of interest associations, or other components of a social graph may be considered social networking content. A language preference may be associated with a social graph component in a number of ways including, but not limited to: a user designation, recognition of a language type by an application, or an inference from the origin of the social graph component. For example, a user's friend may designate a fluency in the Chinese language. As another example, an interest group may be associated with a country with a distinct language, such as where an interest group for Brazilian soccer is associated with the Portuguese language. A social graph component may have more than one language associated with it, similar to the user's language preference.

The second at least one signal may be identical to, similar to, or completely dissimilar from the first at least one signal. For example, the first at least one signal may correspond to those for the user and the second at least one signal may correspond to a social graph component such as a friend group. The friend group may be those individuals who have a high fluency for the German language. The user may have specified a language preference to indicate that the user prefers content in English and that the user has a low proficiency of the German language. In such an instance, the first at least one signal and the second at least one signal may be deemed similar because there is an overlap between the user's language preference (e.g., English primarily, and some German) and the language preference for the social graph component (e.g., German). In some configurations, there may be no overlap between the two signals. For example, the user may specify a language preference as English and the friend group may have a language preference of German. In such a configuration, the two signals do not overlap or are completely dissimilar. In some configurations the first at least one signal may be identical to the second at least one signal. For example, the user may specify the first language preference as English and the friend group may specify the second language preference as English. In all of the foregoing examples, the step of specifying a language preference or indicating a language preference may be deemed as a signal that can be received.

At 330, responsive to the step of determining the second language preference for the social graph component of the social networking application, the first language preference may be compared to the second language preference. The social graph component may be assigned a weighted value based upon the comparison of the first language preference to the second language preference at 340. The weighted value may indicate a likelihood that the user prefers to receive the social graph component associated with a first language. A weighted value may be determined using a variety of techniques such as a clustering algorithm, an agglomerative hierarchical clustering, a k-means clustering, a distributed exchange algorithm, or the like. The more closely aligned the language preference of the social graph component is to the language preference of the user, the more weight it may receive. As a corollary, the less closely aligned the language preference of the social graph component is to the user's language preference the less weight it may receive.

For example, a user may have one or more preferred languages defined in a profile (e.g., language preference). Each language may correspond with a proficiency level. For example, a user may have a proficiency level in English numerically indicated as 1.0, Russian numerically indicated as 0.6, and Polish numerically indicated as 0.1. This may indicate that the user is fluent in English, has a working knowledge of Russian, and a rudimentary fluency of Polish. As disclosed herein, the proficiency level may be input by the user or computationally determined such as by a machine learning method based upon one or more signals, for example, by analyzing a user's content (e.g., the language content in sent/received emails, social posts, news articles, etc.). A confidence level may be assigned for each signal such as a self-declared language, browser language settings (e.g., accept-language), browser build language, IP address of the user, etc. For example, a user's declared language may be assigned a value of 1.0 while a browser build language may be assigned a value of 0.5. A weighted value for a language may be obtained by multiplying the proficiency level by the confidence level of the language signal. The language weights may be utilized to rank and/or prioritize the social stream content for a specific user to match the user's language preferences. In some configurations, the rank of each piece of content (e.g., determined based on others factors, such as user interest, a friend connection, etc.) may be multiplied by the language weight corresponding to the language of the specific piece of content. The social stream may then be ranked again according to the content that best matches the user's language preferences.

As another example, a user's language preference may indicate French, Chinese, and Hindi languages, and that the user has an interest in a French TV show. The interest in the French program may have been determined by the user's activity, such as by determining that the user regularly reads content related to the program. Content related to the program may include, for example, news articles, online posts to the user's web page or the user's friends' web pages related to the program, or linking to content related to the show. The star celebrity of the French TV show may be a person of interest for the user. The social graph component in this example, the celebrity, may be weighted relatively high compared to other social graph components due to the user's demonstrated interest in the celebrity. If a majority of the celebrity's online postings are in French, it may be desirable to suggest the celebrity as a person of interest to those individuals who have indicated the French language as a language preference. Thus, a comparison of the user's language preference to the social graph component (e.g., the celebrity as a person of interest) may indicate a potential match because the French language has been indicated as one of the user's language preferences.

The social graph and/or a social stream component of the social networking application may be presented according to the language preference of the user at 350. A social stream component may refer to a social post, a news item, a suggestion of a friend and/or group, or any other content item associated with a social graph component that may be presented to a user. Continuing the above example, a suggestion may be made to the user inquiring whether the user would like to follow the celebrity. Following the celebrity may indicate, for example, that the user receives a notice of a posting the celebrity makes on the celebrity's web page or that the user may be suggested articles related to the celebrity. The step of presenting may include, for example: filtering a social graph of the user based upon the language preference of the user, publishing to a social networking application, grouping individuals associated with the user, translating content according to the language preference of the user, or the like. Continuing the example above, if the user had a demonstrated interest in the French TV show but did not indicate the French language as a language preference, the person of interest (e.g., the celebrity) may still be suggested to the user. Similarly, when the celebrity posts a message in French, a prompt may be made to offer a translation of the content to a language that is within the purview of the user's language preference. Publishing content may include, but is not limited to, providing a text-based posting to a social networking application that may be presented on a web page on the social networking application, or otherwise making an item available for access by one or more users.

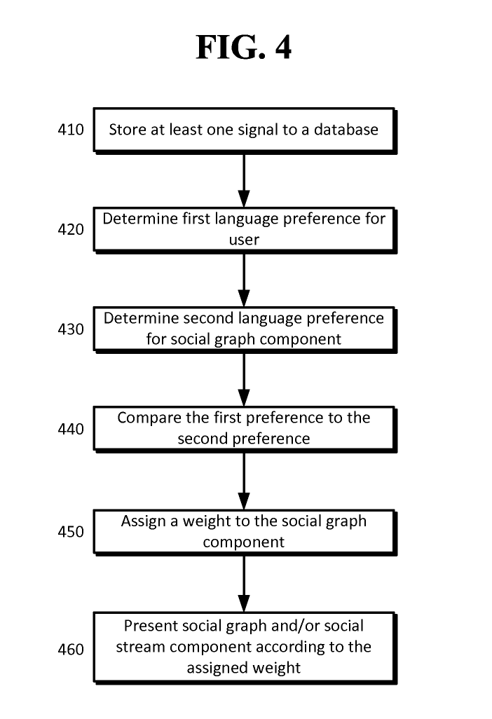

In another implementation of the disclosed subject matter shown in FIG. 4, a database may store one or more signals at 410. A processor directly or indirectly connected to the data base may be configured to determine a first language preference for a user based on at least one of the signals at 420. A second language preference for a social graph component of the social networking application may be determined based on at least one of the signals at 430. Responsive to the step of determining the second language preference for the social graph component of the social networking application, the first language preference may be compared to the second language preference at 440. A weighted value may be assigned to the social graph component based on the comparison of the first language preference to the second language preference at 450 as previously disclosed herein. The processor may be configured to present the social graph component and/or a social stream component associated with the first language at 460, such as by filtering the social graph of the user, suggesting a friend group, suggesting a game partner, suggesting a person to follow, suggesting an interest group, a translation, or the like, as disclosed herein.

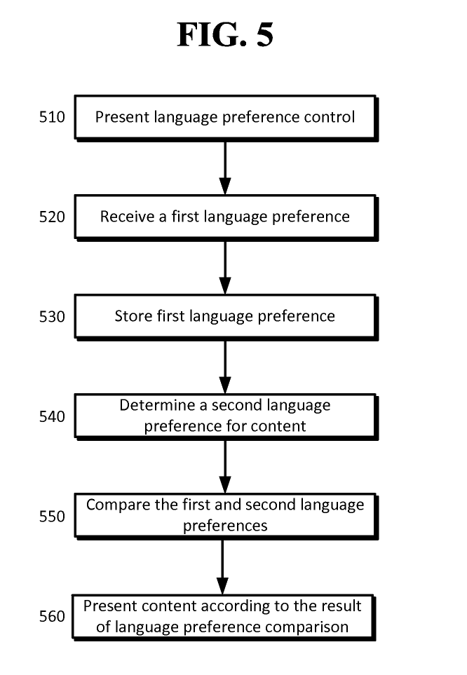

FIG. 5 shows an example of filtering a social graph based on a user's language preference. At 510, information for presenting a language preference selection control may be sent to a user. The language preference selection control may be used to establish a list of languages in which the user would like to have content displayed. It may allow a user to specify a hierarchy for language presentation. For example, if the user desires content in French, Chinese, and Hindi, these languages may be indicated in the language preference selection control. The order of the languages may be utilized for language resolution of content. Continuing the example, if content is not available for the French language, but is available for Chinese or Hindi, a language resolution program may default to the Chinese language for the content because it is the next most-preferred language in which the user desires content to be presented.

A first language preference may be received from a user at 520. A language preference may, for example, include a selection of a language by the user in which to display content. In some configurations, a user may decide not to specify a language. In that instance, the language preference may be inferred from a variety of language indicators besides the user-specified language preference, as disclosed herein.

The first language preference may be stored to and/or accessed from a computer readable medium by, for example, a social networking application at 530. For example, a user may have an online account associated with a social networking application. A language preference may be stored by the social networking application and thereby associated with the account of the user. If the user elects not to input a language preference and the language preference is determined using another language indicator, the language preference may, for example, be stored to and accessed from a local area such as a hard disk drive.

A determination may be made at 540 as to whether content of the social networking application is associated with a second language preference. The first language preference may be compared to the second language preference to determine a language based presentation for the content at 550. Continuing the example with the user who has specified French, Chinese, and Hindi as a language preference, the language of a posting in the French language that the user has made may be determined. The user may have the posting only sent to or displayed to individuals associated with the user who have a language preference that matches the language of the posting. In this example, users who have specified or are otherwise determined as having a language preference that contains the French language may be presented the content.

The content of the social networking application may be presented in accordance with the determination of the language based presentation for the content at 560. The presentation of content may include visual, audio, or tactile methods of presentation. The step of presenting the content may include filtering a social graph of the user based upon the language preference of the user. For example, a user may auto-filter posts from other users who are not using a language that matches a language preference of the user. The step of presenting may also include a translation of the content to a language that matches a language preference of the user. For example a prompt may appear asking the user if she would like a translation of the content. As another example, a user may specify that an application automatically translate content to a language according to the language preference of the user.

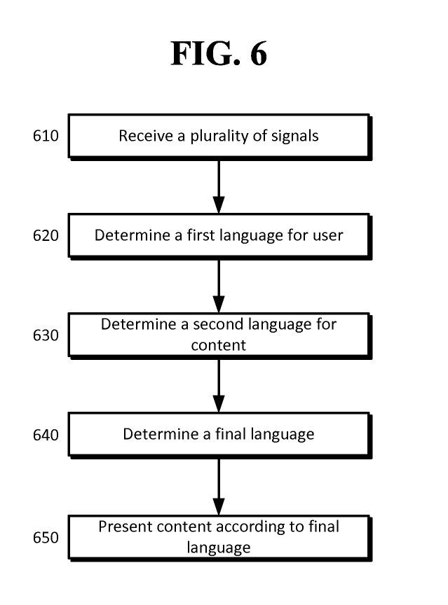

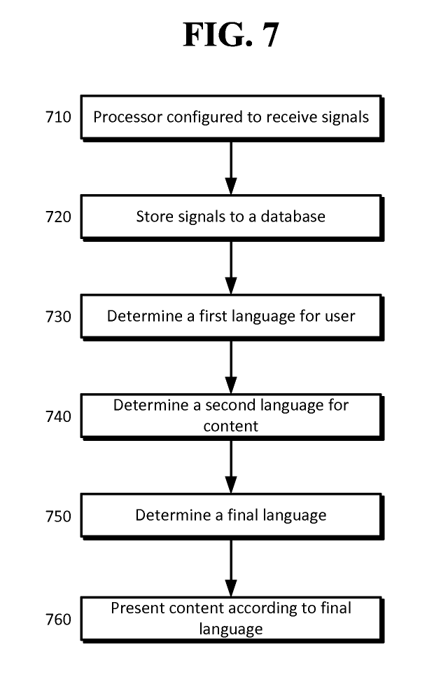

In an implementation, one or more signals, which may include a language preference, may be received at 610, as shown in FIG. 6. The one or more signals may be used to determine the language or languages in which a user desires content to be presented. A language proficiency may be determined as described earlier. A first language for a user may be determined based on at least one of the signals at 620. A second language may be determined for content available to a social networking application based on at least one of the signals at 630. The first language may be compared to the second language to determine a final language at 640. For example, a user may specify only the English language in a language selection control. But, the user may be reading a relatively high number of French articles and write comments in French. An analysis of the signals for this user may indicate that the user would like to receive content in the French and English languages. A piece of content, for example an article, may be analyzed using one or more of the signals to determine a language associated with it. In this example, the article is written in French and it appears to contain subject matter in which the user has indicated an interest. Because the user's determined languages, French and English, align with the subject matter and language of the article, the article may be presented to the user.

The content of the social networking application may be presented in accordance with the determined final language at 650. The step of presenting the content may include, for example, an audio, a video, or a tactile method. The content may be stored to a computer readable medium. The stored content may be accessed for further informatics analysis such as modifying the user's language proficiency.

The step of presenting the content may include promoting a language specified in the language preference of the user. Promoting may refer to modifying the amount of content of the language to be presented to the user. For example, articles of a particular language that is either not among the user's language preference or is not assigned a relatively high priority in the user's language preference, may be promoted in a number of ways. For example, a user may adjust the user's language preference or manually promote such articles based on the origin of the content or the language of the content. The articles may be promoted automatically based on an analysis of the one or more signals. For example, a user's online activity may be analyzed over time to determine if the user appears to be using, viewing, or publishing more content of a particular language or if the user is consistently opting to view content from a particular source (e.g., a German newspaper). If the user appears to be using, viewing, or publishing more content of a particular language the language may be promoted in or added to the user's language preference.

In an implementation, an example of which is provided in FIG. 5, a system is provided that includes a database for storing one or more signals and a processor in connection with the database at 710. The processor may be configured to receive the one or more signals, such as receiving a language preference from a user at 720. The processor may be configured to determine a first language for a user at 730 and a second language for content available to a social networking site at 740 based on at least one of the one or more signals. The first language may be compared to the second language to determine a final language at 750. Content of the social networking application may be presented in accordance with the determined final language 760. The step of presenting the content may include promoting a language specified in the language preference of the user. The promoting may modify the amount of content of the language to be presented to the user. The content of the social networking application may be presented in a variety of ways, such as filtering a social graph of the user based upon the language preference of the user, publishing to a social networking application, grouping individuals associated with the user, translating the content according to the language preference of the user, or the like. In addition, the formatted content of the social networking application may be stored to a computer readable medium.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
determining a first language preference for a user based on at least one of a first plurality of signals;
determining a second language preference for a social graph component of the social networking application, based on at least one of a second plurality of signals;
responsive to the step of determining the second language preference for the social graph component of the social networking application, comparing the first language preference to the second language preference;
assigning a weighted value to the social graph component based on the step of comparing the first language preference to the second language preference, where the more closely aligned the second language preference of the social graph component is to the first language preference of the user, the greater the weighted value it receives; and
presenting a social stream component based upon the weighted value assigned to the social graph component.

2. The method of claim 1, wherein the step of presenting the social stream component comprises filtering the social graph of the user.

3. The method of claim 1, wherein the step of presenting the social stream component comprises suggesting a friend group.

4. The method of claim 1, wherein the step of presenting the social stream component comprises suggesting a game partner.

5. The method of claim 1, wherein the step of presenting the social stream component comprises suggesting a person to follow.

6. The method of claim 1, wherein the step of presenting the social stream component comprises suggesting an interest group.

7. The method of claim 1, wherein the step of presenting the social stream component comprises a translation.

8. The method of claim 1, wherein at least one of the first plurality of signals is selected from the group consisting of: an online activity of the user, a music selection of the user, a media selection of the user, a frequency of posts of the user in a social network application, an email, a comment of the user, a length of a text item accessed by the user, an amount of time spent reading a text item, a text item provided by the user, speech of the user, a language proficiency of the user, or any combination thereof.

9. The method of claim 1, wherein the language preference is determined by a language indicator.

10. The method of claim 1, wherein the weighted value is determined using a method selected from the group consisting of: a clustering algorithm, an agglomerative hierarchical clustering, a k-means clustering, or a distributed exchange algorithm.

11. A system comprising:
a database storing a first plurality of signals;
a processor connected to the database, the processor configured to:
determine a first language preference for a user based on at least one of a first plurality of signals;
determine a second language preference for a social graph component of the social networking application, based on at least one of a second plurality of signals;
responsive to the step of determining the second language preference for the social graph component of the social networking application, compare the first language preference to the second language preference;
assign a weighted value to the social graph component based on the step of comparing the first language preference to the second language preference, where the more closely aligned the second language preference of the social graph component is to the first language preference of the user, the greater the weighted value it receives; and
present the social stream component of the social networking application based upon the weighted value assigned to the social graph component.

12. The system of claim 11, wherein the step of presenting the social stream component comprises filtering the social graph of the user.

13. The system of claim 11, wherein the step of presenting the social graph component comprises suggesting a friend group.

14. The system of claim 11, wherein the step of presenting the social stream component comprises suggesting a game partner.

15. The system of claim 11, wherein the step of presenting the social stream component comprises suggesting a person to follow.

16. The system of claim 11, wherein the step of presenting the social stream component comprises suggesting an interest group.

17. The system of claim 11, wherein the step of presenting the social stream component comprises a translation.

18. The system of claim 11, wherein at least one of the first plurality of signals is selected from the group consisting of: an online activity of the user, a music selection of the user, a media selection of the user, a frequency of posts of the user in a social network application, an email, a comment of the user, a length of a text item accessed by the user, an amount of time spent reading a text item, a text item provided by the user, speech of the user, a language proficiency of the user, or any combination thereof.

19. The system of claim 11, wherein the weighted value is determined using a method selected from the group consisting of: a clustering algorithm, an agglomerative hierarchical clustering, a k-means clustering, or a distributed exchange algorithm.

20. A method comprising:
sending information for presenting a language preference selection control to a user;
receiving a first language preference from a user;
storing the first language preference to a computer readable medium;
accessing the first language preference from the computer readable medium by a social networking application;
determining whether content of the social networking application is associated with a second language preference;
comparing the first language preference to the second language preference to determine a language based presentation for the content; and
presenting the content of the social networking application in accordance with the determination of the language based presentation for the content.

21. The method of claim 20, wherein the step of presenting the content is selected from the group consisting of: filtering a social graph of the user based upon the language preference of the user, or translating the content according to the language preference of the user.

22. A method comprising:
receiving at least one of a plurality of signals;
determining a first language for a user based on at least one of the plurality of signals;
determining a second language for content available to a social networking application based on at least one of the plurality of signals;
comparing the first language to the second language to determine a final language; and
presenting the content of the social networking application in accordance with the determined final language.

23. The method of claim 22, further comprising receiving a language preference from the user.

24. The method of claim 22, wherein the step of presenting the content comprises filtering a social graph of the user based upon at least one of the plurality of signals.

25. The method of claim 22, wherein the step of presenting the content comprises a publishing to a social networking application.

26. The method of claim 22, wherein the step of presenting the content comprises grouping individuals associated with the user.

27. The method of claim 22, wherein the step of presenting the content comprises translating the content according to the language preference of the user.

28. The method of claim 22, wherein the at least one of the plurality of signals is selected from the group consisting of: an online activity of the user, a music selection of the user, a media selection of the user, a frequency of posts of the user in a social network application, an email, a comment of the user, a length of a text item accessed by the user, an amount of time spent reading a text item, a text item provided by the user, a speech of the user, a language proficiency, or any combination thereof.

29. The method of claim 22, further comprising storing the content of the social networking application.

30. The method of claim 22, wherein the step of presenting the content comprises promoting a language specified in the language preference of the user, the promoting modifying the amount of content of the language to be presented to the user.

31. A system comprising:
a database storing a plurality of signals;
a processor in connection with the database, the processor configured to:
determine a first language for a user based on at least one of the plurality of signals;
determine a second language for content available to a social networking application based on at least one of the plurality of signals;
compare the first language to the second language to determine a final language; and
present the content of the social networking application in accordance with the determined final language.

32. The system of claim 31, further comprising receiving a language preference from the user.

33. The system of claim 31, wherein the step of presenting the content comprises filtering a social graph of the user based upon at least one of the plurality of signals.

34. The system of claim 31, wherein the step of presenting the content comprises a publishing to a social networking application.

35. The system of claim 31, wherein the step of presenting the content comprises grouping individuals associated with the user.

36. The system of claim 31, wherein the step of presenting the content comprises translating the content according to the language preference of the user.

37. The system of claim 31, wherein at least one of the plurality of signals is selected from the group consisting of: an online activity of the user, a music selection of the user, a media selection of the user, a frequency of posts of the user in a social network application, an email, a comment of the user, a length of a text item accessed by the user, an amount of time spent reading a text item, a text item provided by the user, a speech of the user, a language proficiency determined, or any combination thereof.

38. The system of claim 31, further comprising storing the content of the social networking application.

39. The system of claim 31, wherein the step of presenting the content comprises promoting a language specified in the language preference of the user, the promoting modifying the amount of content of the language to be presented to the user.
